(19) United States
(12) Patent Application Publication
(10) Pub. No.: US 2006/0070301 A1
(43) Pub. Date: Apr. 6, 2006

(54) Fiber reinforced structural member with cap

(75) Inventors: Stephen Donald Fisher, Warroad, MN (US); Michael Jay Marsh, Warroad, MN (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Marvin Lumber and Cedar Company, d/b/a Marvin Windows and Doors

(21) Appl. No.: 10/958,860

(22) Filed: Oct. 5, 2004

(51) Int. Cl. E06B 1/04

(52) U.S. Cl. 49/504

(57) ABSTRACT

A window or door structural member includes an extruded structural member having at least a thermoplastic and filaments disposed within the thermoplastic. The extruded structural member has a thermal coefficient of expansion of 3×10⁻⁵ in/in ° F. or less and a heat deflection temperature of 210° F. or more. An acrylic cap is coextruded with the extruded structural member and coupled with the extruded structural member. In one option, the extruded structural member includes at least one of a frame member, sash, or panel, and cladding. In another option, a window or door assembly includes a frame and a cladding coupled along the frame. At least one of the frame, sash, or panel, and the cladding includes one or more extruded structural members including at least a thermoplastic and filaments disposed within the thermoplastic.

### TECHNICAL FIELD

A fiber reinforced composite frame member including a cap and in particular a fiber reinforced composite frame member for window and door frames.

### BACKGROUND

Many of the current structural members used with window and door assemblies do not provide sufficient weather resistance, structural strength or are too expensive. In some instances structural members have relatively high coefficients of thermal expansion and low heat deflection temperatures, and are therefore poorly suited for exterior applications that include widely fluctuating temperatures. The variations in temperature cause expansion and contraction of the structural members that affects the stability of a window or door assembly within a wall. Over time, expansion and contraction decreases the structural integrity of the window or door, fatigues materials, and potentially provides a source for potential water leakage.

Additionally, in some examples, structural members for window and door assemblies are constructed with materials that provide insufficient tensile and flexural strength for long term durability of the assembly. Fatigue caused by high winds or the like weakens the window or door assembly requiring early replacement or repair. Further, in other examples, fillers (e.g., wood fiber) are sometimes added generously to building materials, such as siding, to cut costs. Building materials including a large proportion of these fillers are brittle, have decreased tensile strength, and therefore have less durability.

Furthermore, in some examples, structural members for window and door assemblies are constructed with thermoset polymers. Because the structural members are thermoset polymers, if a non-linear geometry (e.g., a curve) is desired, the structural member must be formed with the non-linear geometry. One disadvantage of this type of structural member is it increases the cost of the structural member as non-linear structural members must be constructed with a specific non-linear geometry at the time they are formed. The structural member can not be formed into a variety of non-linear geometries after the initial formation.

In other examples, structural members sometimes include caps that provide a decorative finish and/or conceal the base materials of the members that are not aesthetically appealing. Often the caps are difficult to bond with structural members because of the different materials used in the caps and the structural members. In still other examples, the caps are not resistant to ultraviolet light, such as sunlight. The caps quickly break down becoming unattractive and reducing the aesthetic appeal of the window or door assembly. The susceptibility of the caps to sunlight requires repair or replacement of the cap or use of the structural member for concealed applications away from sunlight.

What is needed is a structural member for a window or door assembly that overcomes the shortcomings of previous structural members. What is further needed is a structural member that is inexpensive to manufacture, has a low coefficient of thermal expansion and provides adequate resistance to environmental conditions (e.g., sunlight and wind).

### SUMMARY

A window or door structural member assembly includes a structural member including at least a thermoplastic and filaments disposed within the thermoplastic. The structural member has a thermal coefficient of expansion of 3.0×10⁻⁵ in/in ° F. or less and a heat deflection temperature of 210° F. (98° C.) or more. An acrylic cap is coformed with the structural member and coupled with the structural member. In one option; the structural member includes at least one of a frame member, sash, or panel, and a cladding. The filaments, in another option, include glass fibers, carbon fibers or the like. In yet another option, the structural member includes wood flour. The thermoplastic includes, acrylonitrile butadiene styrene, in still another option. Optionally, the structural member is formed by extrusion and the acrylic cap is coextruded with the structural member.

Several options for the window or door structural member assembly follow. Optionally, the thermoplastic includes a foamed thermoplastic. At least a portion of the acrylic cap includes a pre-finished wood grain, in one option. At least a portion of the acrylic cap is painted, in another option. The acrylic cap includes, in yet another option, polymethymethacrylate. In still another option, the structural member is hollow.

In another option, a method for making a window or door includes extruding one or more window or door structural members, and the structural members include at least a thermoplastic and filaments disposed within the thermoplastic. The structural members have a thermal coefficient of expansion of around 3.0×10⁻⁵ in/in ° F. or less and a heat deflection temperature of 210° F. or more. The method further includes, coextruding one or more acrylic caps with the window or door structural members, wherein the acrylic caps are coupled with the window or door structural members.

Several options for the method follow. In one option, the method includes heating one or more of the window or door structural members and bending at least a portion of the one or more window or door structural members into a curved geometry. In another option, the ends of one or more window or door structural members are heated. The ends of the one or more window or door structural members are pressed into engagement and the ends bond. The method includes, optionally, cutting the one or more window or door structural members and the acrylic caps.

In another option, the method includes coupling cladding to a frame portion. The one or more window or door structural members includes the cladding and the frame portion. Coupling the cladding to the frame portion includes, in yet another option, positioning a projection extending from the frame portion within a groove of the cladding sized and shaped to receive the projection. Positioning the projection extending from the frame portion within the groove of the cladding includes, in still another option, grasping the frame portion with at least one claw extending from the cladding. Optionally, coupling the cladding to the frame portion includes extending a fastener through the cladding and into the frame portion or bonding with glue or sealant.

The above described structural member for a window or door assembly provides improved structural strength and resistance to environmental conditions, such as sunlight and wind. The acrylic cap provides a decorative finish to the window or door assembly. Additionally, the acrylic cap is durable in sunlit environments (e.g., exterior and interior environments) because it is resistant to degradation caused by sunlight. Moreover, the thermoplastic composite structural member has a coefficient of thermal expansion of at least 3.5×10⁻⁵ in/in ° F. or less (e.g., between about 1×10⁻⁵ in/in ° F. and 3.5×10⁻⁵ in/in ° F.) permitting outdoor use of the member without undesirable contraction and expansion. Where the structural member is one of the cladding or the frame, it is easily mated to respective frame or cladding members including materials with similar or less coefficients of thermal expansion, for instance, ULTREX™. Furthermore, the thermoplastic composite structural member provides enhanced flexural and tensile strength to the window or door assembly. The member thereby provides a stable and durable window or door assembly that is suitable for use in outdoor environments. Further still, the structural member cuts like wood thereby decreasing retooling costs for existing production lines that use wood.

In another option, the structural member is readily manufactured by coforming the thermoplastic material (e.g., acrylonitrile butadiene styrene or the like) including the filaments with the acrylic cap. The nature of the coforming process (e.g., coextrusion, copultrusion or the like) and the chemical attraction between the thermoplastic and the acrylic cap allow the acrylic cap to couple with the structural member without adhesives or the like. Additionally, the structural member is bendable after being formed, such as by coextrusion. In one option, the structural member is produced in lineal unbent sections. The lineal sections are subsequently cut and bent as desired to form structural members for window and door assemblies including decorative curved portions.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### BRIEF DESCRIPTION OF THE DRAWINGS

FIG. 1A is a perspective view of an example of a window assembly including cladding and frame structural members.

FIG. 1B is a front elevational view of another example of a window.

FIG. 1C is a front elevational view of one example of a door.

FIG. 2 is a cross-sectional view of one example of a portion of a window or door.

FIG. 3A is a front elevational view of yet another example of a window.

FIG. 3B is a front elevational view of still another example of a window.

FIG. 4 is a cross-sectional view of another example of a portion of a window taken along line A-A in FIG. 3A.

FIG. 5 is a cross-sectional view of yet another example of a portion of a window taken along line A-A in FIG. 3A.

FIG. 6 is a block diagram illustrating one example of a method of making a window or door assembly.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

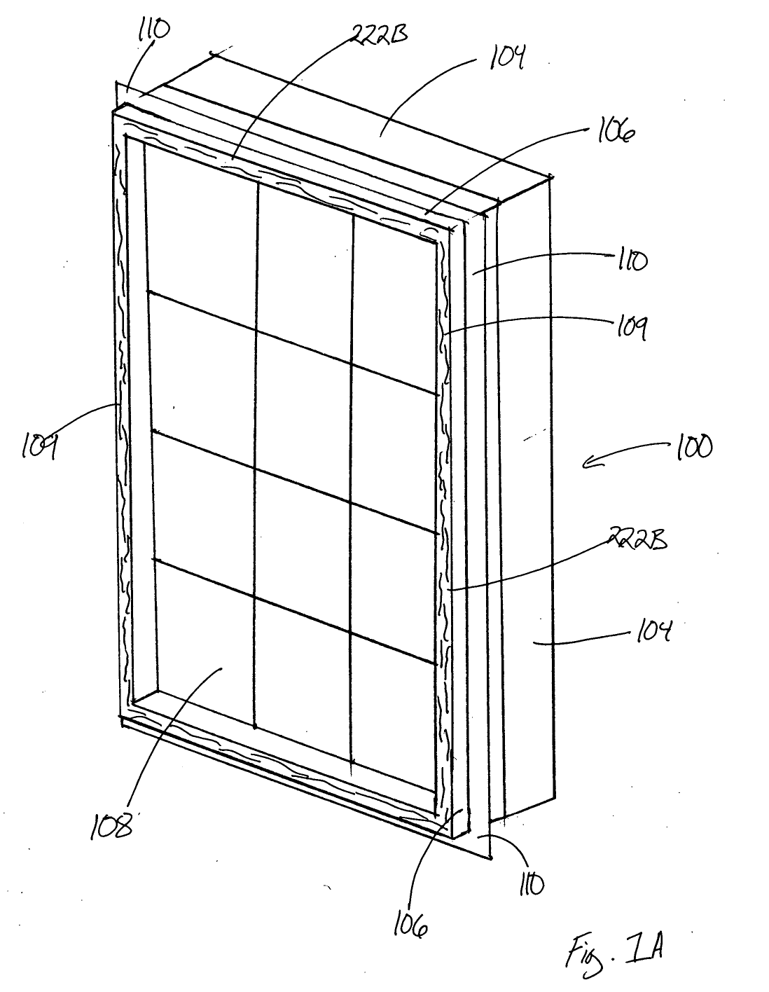

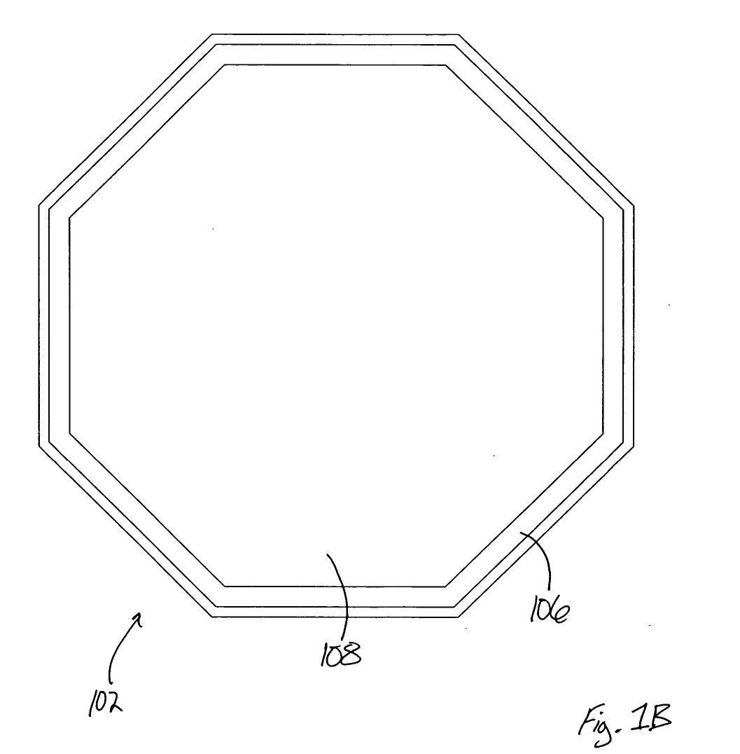

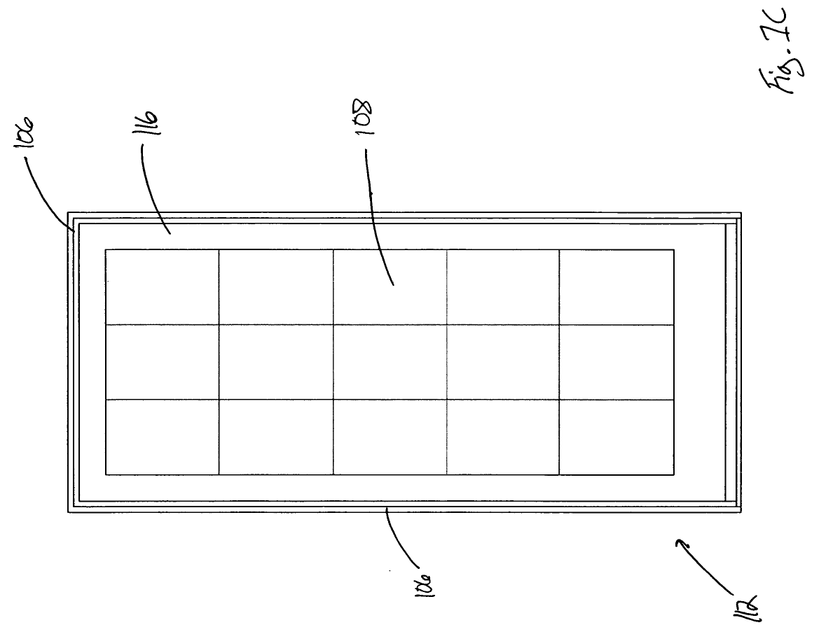

FIGS. 1A, B illustrate two examples of window assemblies 100, 102. It should be noted that the subject matter herein can be used with several types of window assemblies including, but not limited to, double-hung, casement, awning, sliding, or hopper window. As shown in FIG. 1A, the window assembly 100 includes structural members, for instance, a frame 104 and cladding 106. In one option, the cladding 106 and frame 104 surround sashes. The sashes are moveable, in another option, and permit opening of the window assembly 100. As shown in FIGS. 1A, B, the window assemblies 100, 102 include glass panes 108. The window assemblies 100, 102 are direct glaze windows, optionally, and the glass pane 108 is retained between the cladding 106 and the frame 104 (FIG. 1A). In yet another option, the glass pane 108 is retained within a sash moveably coupled to the frame 104 and/or the cladding 106. In still another option, the window assembly 100 is an awning window or hopper window and includes a sash having overlapping glass planes that are rotated (for example by a cranking mechanism). The window assembly 100 is a casement window, optionally, and the sashes rotate around a vertical side of the frame 104. The window assembly 100, in a further option, is a horizontally sliding window with two or more sashes, each moveable within the frame or stationary.

In one option, the window assembly 100 (FIG. 1A) includes a nailing fin 110 extending around at least a portion of the cladding 106. The nailing fin 110 is sized and shaped to engage against a surface, for instance a wall. Nails, screws, staples or the like are driven through the nailing fin 110 into the surface to couple the window assembly 100 with the surface. Optionally, the nailing fin 110 assists in preventing moisture and air movement from one side of a wall to the other (e.g., from outside to inside). In another option, flashing and/or tape are placed around the window assembly 100 and over top of the nailing fin 110 to seal the window assembly 100 against a surface. It should be noted that flashing and/or tape, for example, can be used without the nailing fin.

Referring now to FIG. 1B, in another option, the window assembly 102 has an octagonal geometry. In yet another option, the window assembly includes, but is not limited to, ovular, circular, pentagonal geometries or the like. Optionally, the glass pane 108 is retained between the cladding 106 and the frame of the window assembly 102.

FIG. 1C illustrates a door assembly 112. Similar to the window assembly 100, 102, the door assembly 112 includes structural members such as a frame and cladding 106. The frame and cladding 106 extend at least part way around a door 116. The door 116 is, in one option, rotatably coupled with the frame to allow opening and closing of the door. In one option, the door 116 includes a glass pane 108. The glass pane 108 is retained within the door 116 with brackets, adhesives or the like. In another option, the door assembly 112 includes a nailing fin similar to the nailing fin 110 described above. The nailing fin of the door assembly 112 facilitates coupling of the door assembly 112 with a surface, such as a wall.

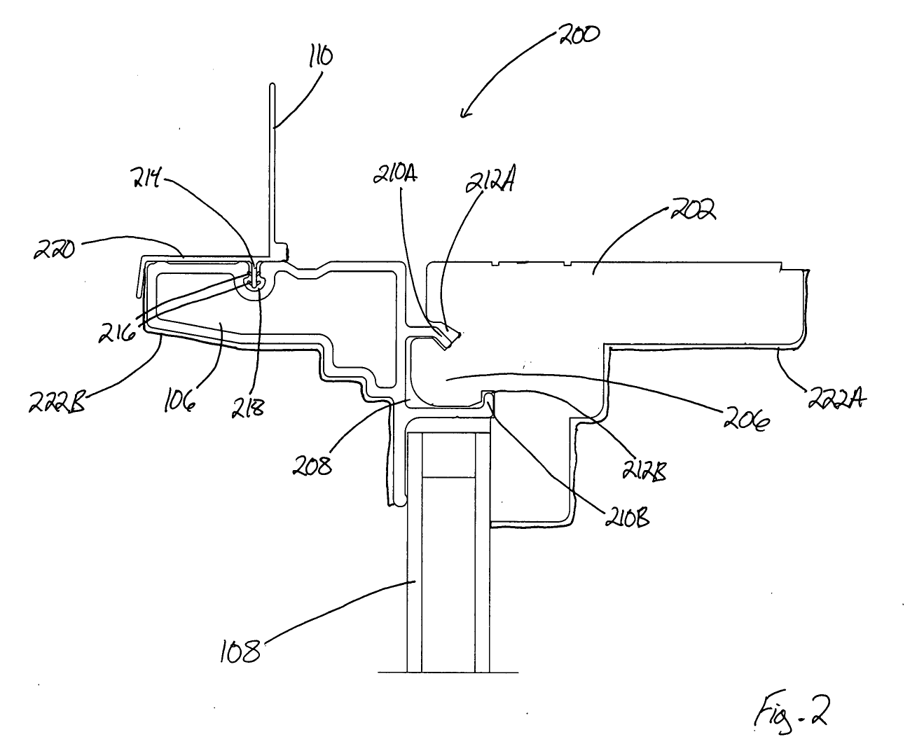

FIG. 2 is a sectional view illustrating a portion of at least one of the window assemblies 100, 102. In one option, the window assemblies 100, 102 (FIGS. 1A, B) include structural members such as cladding 106 and frame portions 202. In another option, the door assembly 112, which is optionally fixed, includes structural members such as cladding 106 and frame portions 202. The frame portions 202 form the frame 104 (FIG. 1A). The cladding 106 provides additional support to the frame 104 and also acts as the exterior surface of the window and door assemblies 100, 102, 112 (FIGS. 1A, B, C). The structural members form the supporting structure for the window and door assemblies 100, 102, 112. The cladding 106 and the frame portion 202, in another option, retain a glass pane 108 therebetween (See FIG. 1A, B). Optionally, a sealant such as silicone or the like is applied between the glass pane 108 and the cladding 106 and also between the frame portion 202 and the glass pane 108 to prevent moisture and air flow around the glass pane 108.

As shown in FIG. 2 the cladding 106 and the frame portion 202 are coupled together. In one option, the cladding 106 is mechanically coupled with the frame portion 202, for instance, with nails, adhesives, double-sided tape or the like. In one example, the frame portion 202 includes at least one projection 206. The cladding 106 includes a groove 208 sized and shaped to snugly receive the at least one projection 206. In another example, the cladding 106 includes claws 210A, B sized and shaped to engage against the frame portion 202 and retain the cladding 106 against the frame portion 202. Optionally, the frame portion 202 includes recesses 212A, B sized and shaped to receive the claws 210A, B. The recesses 212A, B are formed adjacent to the projection 206. The projection 206, claws 210A, B and the recesses 212A, B cooperate to couple the cladding 106 with the frame portion 202. The projection 206 is inserted into the groove 208 and the frame portion 202 is rotated so the projection 206 moves fully into the groove 208. The claw 210A is received within the recess 212A and grasps the frame portion 202 so the frame portion 202 rotates around the claw 210A. The claw 210B is then received within the recess 210B so the projection 206 is grasped by the claws 210A, B to couple the cladding 106 to the frame portion 202.

In another option, the nailing fin 110 is coupled to the cladding 106 and extends around the window or door assembly, as described above. The nailing fin 110 includes, but is not limited to aluminum, steel, rubber, plastic or the like. A projection 214 extends from the nailing fin 110, in yet another option. The projection 214 includes deformable barbs 216, sized and shaped to engage the surfaces defining a channel 218 in the cladding 106. As the projection 214 is inserted within the channel 218, the barbs 216 deform and provide an interference fit between the nailing fin 110 and the cladding 106. Optionally, the nailing fin 110 includes a skirt 220 extending over at least a portion of the cladding 106. The skirt 220 extends at least part way around the window or door assembly to prevent water and debris from resting directly on the cladding 106. In one example, the skirt 220 is disposed along a top portion of the cladding 106.

At least one of the structural members (including but not limited to the cladding 106 and the frame portions 202 of FIG. 2 or a sash or panel) of the window and door assemblies 100, 102, 112 shown in FIGS. 1A, B, C includes a composite of a thermoplastic and filaments (e.g., glass fibers, carbon fibers, or the like) formed for instance, by extrusion, pultrusion, vacuum or thermal forming, or injection molding, or the like. The structural members provide the framework for the window and door assemblies 100, 102, 112. Additionally, the structural members predominantly bear the loads (e.g., flexural and tensile) experienced by the window and door assemblies 100, 102, 112. The thermoplastic used in the composite material includes a foamed thermoplastic, in one option. The structural member (e.g., the cladding 106 and/or the frame portion 202) including the thermoplastic composite material is hollow in another option. The hollow structural member is formed with, for example, an extrusion die sized and shaped to form a cavity within the structural member.

Optionally, the thermoplastic includes, but is not limited to, acrylonitrile butadiene styrene (ABS), polyvinyl chloride (PVC), urethanes, high impact polystyrene or the like. In one example, the frame portion 202 (FIG. 2) includes a composite including polyurethane and glass fibers sold under the name ISOPLAST™, a registered trademark of the Dow Chemical Company. The frame portion 202 includes, in another option, a thermoplastic composite of acrylonitrile butadiene styrene and glass fibers. The glass fibers provide enhanced tensile and flexural strength to the structural members of the frame thereby increasing the durability of the window and door assemblies 100, 102, 112 (FIGS. 1A, B, C). Additionally, the glass fibers cooperate with the thermoplastic to increase the heat deflection temperature and decrease the coefficient of thermal expansion of the frame portion 202 correspondingly increasing the heat resistance of the frame portion 202 to high temperatures. The glass fibers further enhance at least the coefficient of thermal expansion and the tensile strength of the frame portion 202 when extruded or pultruded with the frame portion 202. The extrusion or pultrusion process substantially aligns the glass fibers in the direction of the frame portion 202 length thereby further lowering the coefficient of thermal expansion and increasing the tensile strength of the frame portion 202 along the frame portion 202 length.

In one option, the thermoplastic composite with acrylonitrile butadiene styrene and 10% by volume glass fibers has a coefficient of thermal expansion of around 2.9×10⁻⁵ in/in ° F., a heat deflection temperature of 220° F., and tensile and flexural strengths of greater than about 8.6 kpsi and 15.0 kpsi, respectively. The thermoplastic acrylonitrile butadiene styrene composite material, in another option, with 40% of glass fibers has a coefficient of thermal expansion of around 1.3×10⁻⁵ in/in ° F., a heat deflection temperature of 230° F., and tensile and flexural strengths of greater than about 15.5 kpsi and 19.0 kpsi, respectively. The preceding options are presented as examples only and the frame portion 202 and/or cladding 106 could have a variety of ratios of glass fibers to thermoplastic. For example, the ratio of glass fibers to thermoplastic ranges from 1% to 50% or more. In one option, the frame portion 202 and/or cladding 106 have a range of coefficients of thermal expansion from about 1×10⁻⁵ in/in ° F. to 3.5×10⁻⁵ in/in ° F. In another option, the frame portion 202 and/or the cladding 106 have a range of coefficients of thermal expansion from about 1.3×10⁻⁵ in/in ° F. to 3×10⁻⁵ in/in ° F. Additionally, the frame portion 202 and/or cladding 106 have a range of heat deflection temperatures from about 210° F. to about 230° F. In still another option, the frame portion 202 and/or cladding 106 have a range of heat deflection temperatures from about 215° F. to about 230° F. The glass fibers increase the heat deflection temperature and lower the coefficient of thermal expansion of the thermoplastic composite. Optionally, the thermoplastic composite used with the structural members of the window and door assemblies 100, 102, 112 (FIGS. 1A, B, C) has a coefficient of thermal expansion of 3.0×10⁻⁵ in/in ° F. or less and heat deflection temperatures of at least 210° F. In another option, the thermoplastic composite includes sufficient fibers (e.g., glass fibers, carbon fibers or the like) to have a coefficient of thermal expansion of 1.3×10⁻⁵ in/in ° F. or less and heat deflection temperatures of at least 215° F. The structural member with the thermoplastic composite is resistant to expansion and contraction due to temperature changes and is also durable at high temperatures. Additionally, the thermoplastic composite structural member cuts like wood, thereby eliminating the need to retool existing production lines adapted to form wooden structural members.

In another option, the thermoplastic composite structural members include other components, for instance, wood fibers, carbon fibers or the like. Wood fibers, such as wood flour, act as a filler that have little effect on the properties of the thermoplastic composite structural members when used in small proportions, for instance 20% by volume or less. When used in limited amounts, wood fiber fillers decrease the overall cost of the frame portion 202 and/or the cladding 106. In yet another option, carbon fibers supplement the glass fibers to provide increased strength, durability and heat resistance to the structural members. Carbon fibers are used in place of glass fibers, in still another option, and are extruded or pultruded with the structural member as described above. Optionally, the thermoplastic composite structural members include fibers constructed with KEVLAR™ a registered trademark of the E.I. DuPont de Nemours and Company Corporation.

The cladding 106, in one option includes, but is not limited to, a thermoset composite of polyester and glass fibers, such as ULTREX™ a registered trademark of Tecton Products, LLC. ULTREX™ has a coefficient of thermal expansion of around 0.3 to 0.6×10⁻⁵ in/in ° F. and a heat deflection temperature of 350° F. The frame portion 202 is constructed with the thermoplastic composite material described above, and includes a thermoplastic (e.g., acrylonitrile butadiene styrene or the like) and glass fibers, in another option. The low coefficient of thermal expansion and the high heat deflection temperature of the thermoplastic composite material allow the frame portion 202 to readily mate with the cladding 106 to provide stable window and door assemblies 100, 102, 112 (FIGS. 1A, B, C). Changes in temperature do not cause the frame portion 202 to expand or contract at such different rates from the cladding 106 that strain is experienced between the two pieces thereby causing movement, such as bowing of the window or door assembly. Additionally, because the frame portion 202 and the cladding 106 have similar coefficients of thermal expansion, minimal shearing forces are experienced by sealants between the glass pane 108 and the cladding 106, and the glass pane 108 and the frame portion 202. The glass pane 108 thereby remains sealed within the window assemblies 100, 102 despite temperature changes. Moreover, the cladding 106 and the frame portion 202 provide a durable and strong window or door assembly 100, 102, 112 capable of withstanding repeated loading from forces, such as wind. The thermoplastic composite material including filaments (e.g., glass fibers) is a low cost alternative to constructing the window or door assembly 100, 102, 112 predominantly out of an expensive material such as ULTREX™.

In another option, the frame portion 202 includes ULTREX™ and the cladding 106 includes the composite material having the thermoplastic (e.g., acrylonitrile butadiene styrene) and glass fibers. The cladding 106, in yet another option, includes aluminum, steel or the like and the frame portion 202 includes the thermoplastic composite material described above. Optionally, the cladding 106 includes the thermoplastic composite material and the frame portion 202 includes wood. The cladding 106 and the frame portion 202 are both constructed with the thermoplastic composite material, in one option. A portion of the cladding 106 includes materials different from another portion of the cladding 106, optionally, for instance aluminum and the thermoplastic composite material. Similarly, in another option, segments of the frame portion 202 includes different materials (e.g., wood and the thermoplastic composite material). In still another option, the frame portion 202 and the cladding 106 all include the thermoplastic composite material.

As shown in FIG. 2, the cladding 106 and the frame portion 202 include acrylic caps 222A, B. The acrylic caps 222A, B are coupled with the cladding 106 and the frame portion 202 by, for instance, coextrusion or copultrusion with the respective structural members. The materials of the cladding 106 and the frame portion 202 easily bond with the acrylic caps 222A, B and provide a durable coupling. In one option, the acrylic caps 222A, B easily couple with at least one of the frame portion 202 and the cladding 106 that includes the thermoplastic composite material described above. The thermoplastic (e.g., acrylonitrile butadiene styrene) and acrylic in the caps 222A, B are attracted to each other thereby facilitating the bond. Adhesives and additional manufacturing steps are unnecessary because the acrylic caps 222A, B directly bond with the frame portion 202 and the cladding 106. The cladding 106, optionally includes ULTREX™ and the frame portion 202 includes the thermoplastic composite material. In another option, the acrylic cap 222A coupled with the frame portion 202 includes a TUFCOAT™ 4550 acrylic including polymethylmethacrylate. TUFCOAT™ is a registered trademark of Lucite International, Inc. In yet another option, the acrylic cap 222B coupled with the cladding 106 includes a TUFCOAT™ 40400 acrylic including polymethylmethacrylate.

The acrylic caps 222A, B provide a decorative finish that includes, but is not limited to, wood grain finishes, painted finishes or the like. One example of wood grain finish 109 on the acrylic cap 222B is shown in FIG. 1A. The acrylic caps 222A, B easily bond with paint to allow a variety of desired painted finishes. Optionally, the acrylic caps 222A, B are painted prior to installation of the window or door assembly 100, 102, 112 (FIGS. 1A, B, C), for instance during manufacture or at a job site. In another option, the acrylic caps 222A, B are painted after installation. Additionally, the acrylic caps 410A, B, C, D are resistant to ultraviolet light and thereby provide a durable finish to the window assemblies 300, 308 for interior and exterior use.

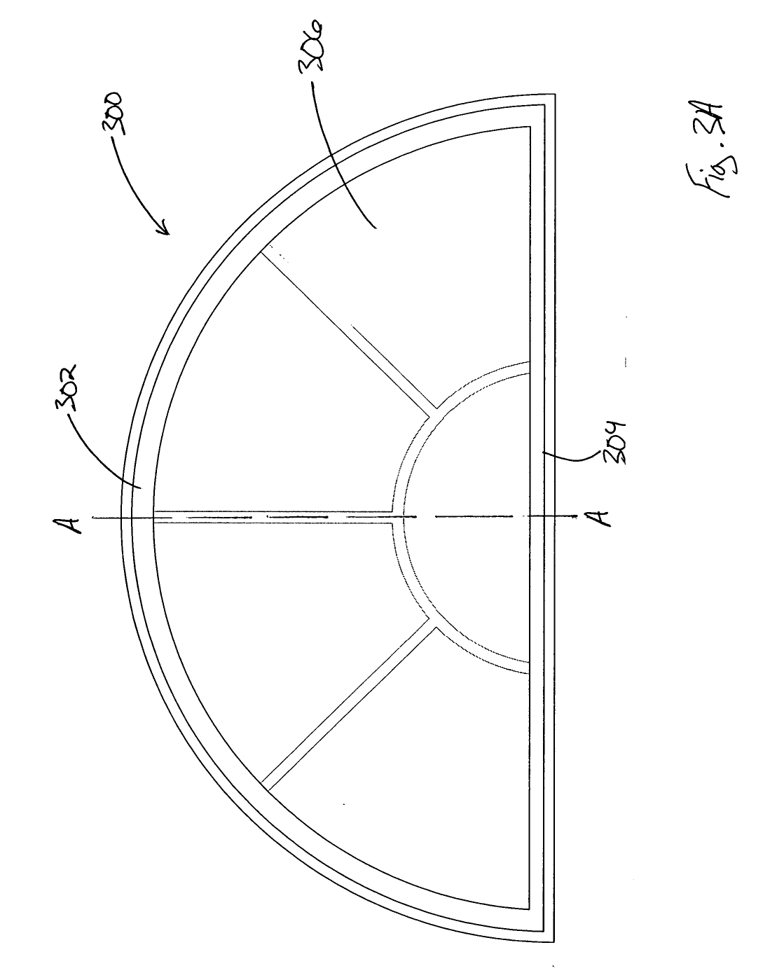

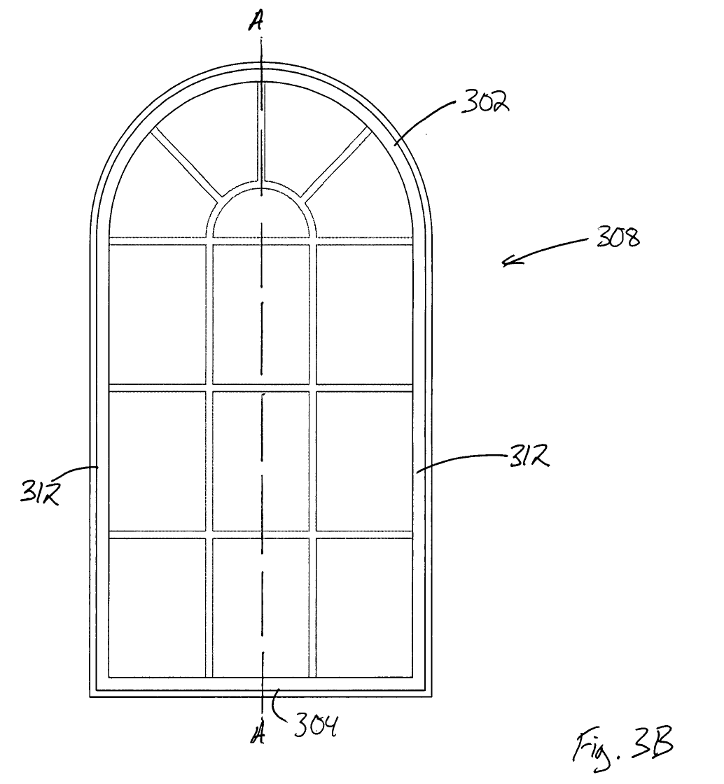

FIG. 3A illustrates another example of a window assembly 300. The window assembly 300 includes a curved member 302 and a sill member 304 coupled to the curved member 302. Both the curved member 302 and the sill member 304 include structural members, such as cladding and frame portions, further described below. The curved member 302 and the sill member 304 surround and retain a glass pane 306 therebetween.

FIG. 3B illustrates yet another example of a window assembly 308 including a curved member 302. The window assembly 308 further includes jamb members 312 coupled to the curved member 302 and a sill member 304 coupled to the jamb members 312. A glass pane 316 is retained by the curved member 302, jamb members 312 and the sill member 304. Similar to the window assembly 300 (FIG. 3A), the window assembly 308 includes structural members (e.g., cladding and frame portions).

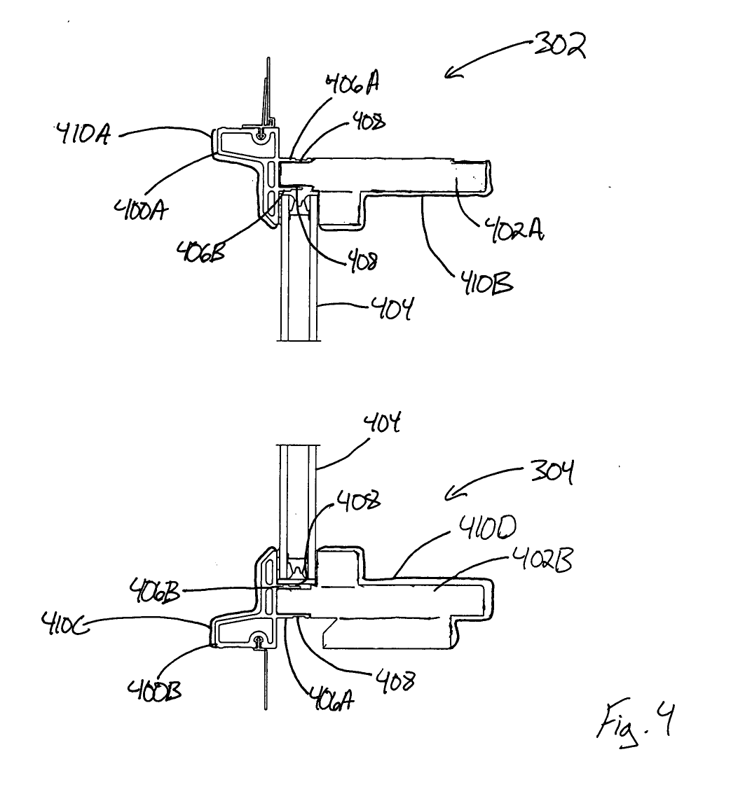

FIG. 4 shows a cross-sectional view of the window assemblies 300, 308 taken along the lines A-A in FIGS. 3A, B. FIG. 4 shows cross sections of the curved member 302 and the sill member 304. The curved member 302 and the sill member 304 include structural members, such as the cladding 400A, B and frame portions 402A, B. Similar to the window assemblies 100, 102 a glass pane 404 is retained between the cladding 400A, B and the frame portions 402A, B. In one option, the glass pane 404 is sealed between the cladding 400A, B and the frame portions 402A, B with a sealant, such as silicone or the like.

The cladding 400A, B shown in FIG. 4 includes claws 406A, B extending from the cladding 400A, B over at least a portion of the frame portions 402A, B. The claws 406A, B include, in one option, necks 408. The necks 408 are narrower than the rest of the claws 406A, B to facilitate puncturing by fasteners (e.g., screws, nails, staples or the like) extending into the frame portions 402A, B to couple the cladding 400A, B to the frame portions. In another option, adhesives couple the cladding 400A, B to the frame portions 402A, B. Similar to the claws 210A, B and the projection 206 shown in FIG. 2, in yet another option, the claws 406A, B grasp projections extending from the frame portions 402A, B to couple the cladding 400A, B with the frame portions 402A, B.

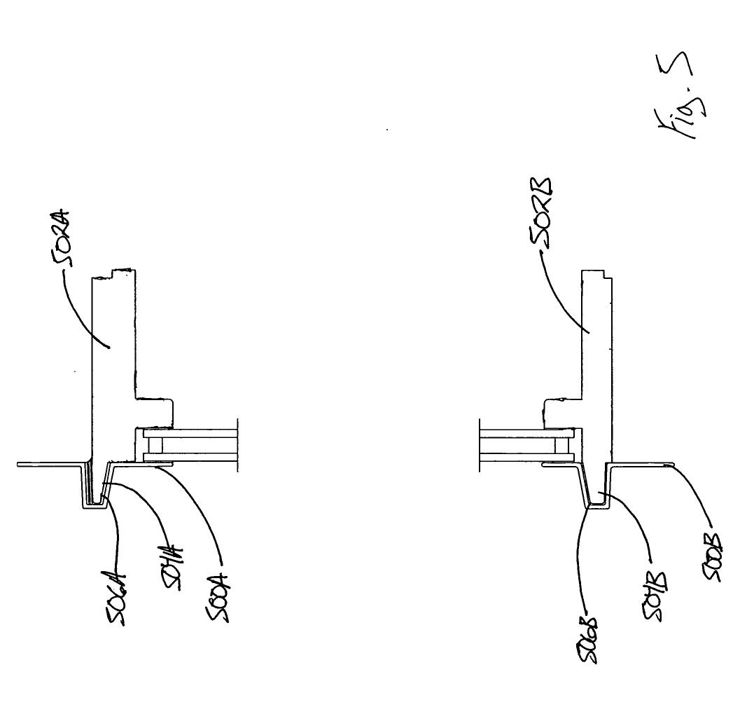

As shown in FIG. 5, in another option, frame portions 502A, B include projections 504A, B and the cladding 500A, B includes recesses 506A, B sized and shaped to receive the projections 504A, B. The projections 504A, B are received within the recesses 506A, B to couple the cladding 500A, B with the frame portions 502A, B. Optionally, an adhesive or liquid sealant is disposed within the recesses 506A, B to ensure a secure coupling between the cladding 500A, B and the frame portions 502A, B.

At least one of the structural members (e.g., the cladding 400A, B and frame portions 402A, B) of the window assemblies 300, 308 includes a composite having a thermoplastic and filaments therein, as described above for window and door assemblies 100, 102, 112 (FIGS. 1A, B, C). The structural member (e.g., the cladding 400A, B and/or the frame portions 402A, B) including the thermoplastic composite material is hollow in one option. The thermoplastic used in the composite material includes a foamed thermoplastic, in another option.

In one option, the thermoplastic composite structural member includes, for instance, wood fibers, carbon fibers or the like. The thermoplastic includes, but is not limited to, acrylonitrile butadiene styrene (ABS), polyvinyl chloride (PVC), urethanes or the like. The frame portions 402A, B include, in another option, a thermoplastic composite of acrylonitrile butadiene styrene and glass fibers. The glass fibers provide enhanced tensile and flexural strength to the structural members of the frame thereby increasing the durability of the window assemblies 300, 308 (FIGS. 3A, B). Additionally, the glass fibers cooperate with the thermoplastic to increase the heat deflection temperature and decreases the coefficient of thermal expansion of the frame portions 402A, B correspondingly increasing the heat resistance of the frame portions 402A, B to high temperatures. The glass fibers further enhance at least the coefficient of thermal expansion and the tensile strength of the frame portions 402A, B when extruded or pultruded with the frame portions. The extrusion or pultrusion process substantially aligns the glass fibers in the direction of the frame portions 402A, B lengths thereby further lowering the coefficient of thermal expansion and increasing the tensile strength of the frame portion 402A, B along the frame portions 402A, B lengths.

As described above with the window and door assemblies 100, 102, 112 (FIGS. 1A, B, C), in one option, the thermoplastic acrylonitrile butadiene styrene composite material with 40% by volume of glass fibers has a coefficient of thermal expansion of around 1.3×10⁻⁵ in/in ° F., a heat deflection temperature of 230° F., and tensile and flexural strengths of greater than about 15.5 kpsi and 19.0 kpsi, respectively. The thermoplastic composite with acrylonitrile butadiene styrene and 10% glass fibers, in another option, has a coefficient of thermal expansion of around 2.9×10⁻⁵ in/in ° F., a heat deflection temperature of 220° F., and tensile and flexural strengths of greater than about 8.6 kpsi and 15.0 kpsi, respectively. The preceding options are presented as examples only and the frame portions 402A, B and/or cladding 400A, B could have a variety of ratios of glass fibers to thermoplastic. For example, the ratio of glass fibers to thermoplastic ranges from 1% to 50% or more. In one option, the frame portions 402A, B and/or cladding 400A, B have a range of coefficients of thermal expansion from about 1×10⁻⁵ in/in ° F. to 3.5×10⁻⁵ in/in ° F. In another option, the frame portions 402A, B and/or the cladding 400A, B have a range of coefficients of thermal expansion from about 1.3×10⁻⁵ in/in ° F. to 3×10⁻⁵ in/in ° F. Additionally, the frame portion 402A, B and/or cladding 400A, B have a range of heat deflection temperatures from about 210° F. to about 230° F. In still another option, the frame portion 402A, B and/or cladding 400A, B have a range of heat deflection temperatures from about 215° F. to about 230° F. Optionally, the thermoplastic composite used with the structural members of the window assemblies 300, 308 (FIGS. 3A, B) has a coefficient of thermal expansion of 3.0×10⁻⁵ in/in ° F. or less and heat deflection temperatures of at least 210° F. In another option, the thermoplastic composite includes sufficient fibers (e.g., glass fibers, carbon fibers or the like) to have a coefficient of thermal expansion of 1.3×10⁻⁵ in/in ° F. or less and heat deflection temperatures of at least 215° F. The structural member with the thermoplastic composite is resistant to expansion and contraction due to temperature changes and is also durable at high temperatures.

The cladding 400A, B, in one option includes, but is not limited to, a thermoset composite of polyester and glass fibers, such as ULTREX™. The frame portions 400A, B are constructed with the thermoplastic composite material described above, and include a thermoplastic (e.g., acrylonitrile butadiene styrene or the like) and glass fibers. The low coefficient of thermal expansion of the thermoplastic composite material allow the frame portions 402A, B to readily mate with the cladding 400A, B to provide stable window assemblies 300, 308. Because the cladding 400A, B and the frame portions 402A, B have similar coefficients of thermal expansion the cladding 400A, B and the frame portions 400A, B do not substantially expand or contract differently to cause strain in the window assemblies 300, 308. Additionally, the similarity of the coefficients of thermal expansions of the cladding 400A, B and the frame portion 402A, B minimizes shearing forces experienced by sealants between the glass pane 404 and the cladding, and the glass pane 404 and the frame portions. The glass pane 404 thereby remains sealed within the window assemblies 300, 308 despite temperature changes. Moreover, the cladding 400A, B and the frame portions 402A, B provide durable and strong window assemblies 300, 308 capable of withstanding repeated loading from forces, such as wind. The thermoplastic composite material is a low cost alternative to constructing the window assemblies 300, 308 predominantly out of an expensive material such as ULTREX™. Similarly to the cladding 400A, B, and the frame portions 402A, B, at least one of the cladding 500A, B and the frame portions 502A, B (FIG. 5) include the thermoplastic composite material in arrangements like those described in the options above.

As described above for the frame portion 202 and the cladding 106 (FIG. 2), the materials of the cladding 400A, B and frame portions 402A, B are varied in different options. In one option, the frame portions 402A, B includes ULTREX™ and the cladding 400A, B includes the composite material having the thermoplastic (e.g., acrylonitrile butadiene styrene) and glass fibers. In another option, the cladding 400A, B includes, but is not limited to aluminum, steel, or the like and the frame portions 402A, B include the thermoplastic composite material described above. In yet another option, the cladding 400A, B includes the thermoplastic composite material and at least the frame portion 402A includes wood (e.g. laminated sheets of wood having the geometry of the curved member 302). The cladding 400A includes materials different from the cladding 400B, optionally, for instance aluminum and the thermoplastic composite material. Similarly, in another option, the frame portions 402A, B include different materials (e.g., wood and the thermoplastic composite material). In still another option, the frame portions 402A, B and the cladding 400A, B all include the thermoplastic composite material.

In one option, where at least the curved member 302 (FIGS. 3A, B) includes structural members including the thermoplastic composite material, the thermoplastic portion of the curved member 302 is formed by bending a lineal length of the structural member including the thermoplastic composite into the desired geometry. In another option, the structural members include, optionally, the cladding 400A and the frame portion 402A (FIG. 4). Where at least one of the frame portion 402A and the cladding 400A includes the thermoplastic composite, the frame portion 402A and/or the cladding 400A are softened by heating. The cladding 400A and/or the frame portion 402A are then bent using a form having the desired geometry. The geometry of the form is imparted to the cladding and/or the frame portion. In another option, the cladding 400A and the frame portion 402A are coupled together and heated and bent as a unitary piece to form the curved member 302. The cladding 400A and the frame portion 402A are heated and bent separately, in yet another option. In still another option, the cladding 400A includes the thermoset ULTREX™, and the thermoplastic composite frame portion 402A is heated and bent separately from the cladding 400A. The frame portion 402A is then coupled to the cladding 400A having a complementary geometry. The thermoplastic composite cladding 400A and frame portion 402A are easy to store as straight lineal lengths prior to bending. Additionally, the cladding 400A and the frame portion 402A are cut and bent to form the curved member 302 having a particular desired geometry when needed from straight lineal lengths already on hand. It is not necessary to store a variety of curved members 302 having different geometries.

Referring again to FIGS. 3A, B, in another option, the curved member 302 is coupled to the sill member 304 (FIG. 3A) or the jamb members 312 (FIG. 3B) with adhesives, mechanical fasteners, welding or the like. The ends of the curved member 302 are heated in one option, for instance with a heated knife surface. Corresponding ends of the sill member 304 or the jamb members 312 are heated. The heated ends of the curved member 302 are engaged against the heated ends of either the sill member 304 or the jamb members 312 and the ends melt together to form the window assemblies 300, 308. In yet another option, the curved member 302 is coupled to the sill member 304 or the jamb members 312 with ultrasonic welding. Mechanical fasteners including, but not limited to, screws, nails, staples, clamps or the like are used to couple the curved member 302 to the jamb members 312 or the sill member 304, optionally.

As shown in FIG. 4, the cladding 400A, B and the frame portions 402A, B include acrylic caps 410A, B, C, D. The acrylic caps 410A, B, C, D are coupled with the cladding 106 and the frame portion 202 by, coforming (e.g., coextrusion, copultrusion, or the like) with the respective structural members. The materials of the cladding 400A, B and the frame portions 402A, B easily bond with the acrylic caps 410A, B, C, D during coformation, such as with coextrusion. The thermoplastic in at least one of the structural members (e.g., the cladding 400A, B and the frame portions 402A, B) and acrylic in the caps 410A, B, C, D are attracted to each other thereby facilitating the bond. Adhesives and additional manufacturing steps are unnecessary because the acrylic caps 410A, B, C, D directly bond with the frame portions 402A, B and the cladding 400A, B during coextrusion. In another option, the acrylic caps 4101B, D coupled with the frame portions 402A, B include a TUFCOAT™ 4550 acrylic including polymethylmethacrylate. In yet another option, the acrylic caps 400A, C coupled with the cladding 400A, B include a TUFCOA™ 40400 acrylic including polymethylmethacrylate.

The acrylic caps 410A, B, C, D provide a decorative finish that includes, but is not limited to, wood grain finishes, painted finishes or the like. The acrylic caps 410A, B, C, D easily bond with paint to allow a variety of desired painted finishes. Optionally, the acrylic caps 410A, B, C, D are painted prior to installation of the window assemblies 300, 308 (FIGS. 3A, B), for instance during manufacture or at a job site. In another option, the acrylic caps 410A, B, C, D are painted after installation. The acrylic caps 410A, B, C, D bend with the thermoplastic structural members, such as the cladding 400A, B and the frame portions 402A, B, when heated and bent to form the curved member 302. Additionally, the acrylic caps 410A, B, C, D are resistant to ultraviolet light and thereby provide a durable finish to the window assemblies 300, 308 for interior and exterior use.

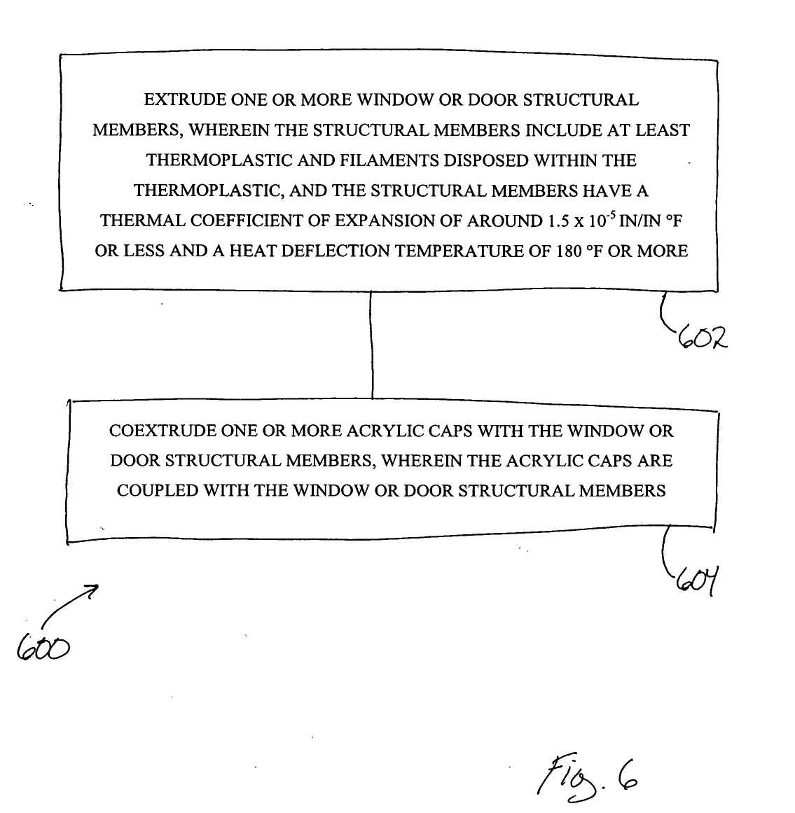

FIG. 6 is a block diagram illustrating a method 600 for making a window or door assembly. At 602, one or more window or door structural members are extruded. The structural members include at least a thermoplastic and filaments disposed within the thermoplastic, and the structural members have a thermal coefficient of expansion of around 3.0×10−5 in/in ° F. or less and a heat deflection temperature of 210° F. or more. At 604, one or more acrylic caps are coextruded with the window or door structural members, wherein the acrylic caps are coupled with the window or door structural members. Optionally, the method 600 includes heating one or more of the window or door structural members, and bending at least a portion of the one or more window or door structural members into a curved geometry.

Several options for the method 600 follow. In one option, ends of one or more window or door structural members are heated (e.g., with a heated knife). The ends of the one or more window or door structural members are pressed into engagement and the ends bond. The method 600 includes, in another option, cutting the one or more window or door structural members and the acrylic caps.

In another option, the method 600 includes coupling cladding to a frame portion. The structural members include the cladding and the frame portion. A projection extending from the frame portion is positioned within a groove of the cladding sized and shaped to receive the projection, in yet another option. Optionally, the projection extending from the frame is grasped with at least one claw extending from the cladding. The method 600 includes, in yet another option, extending a fastener through the cladding and into the frame.

The above described structural member for a window or door assembly provides improved structural strength and resistance to environmental conditions, such as sunlight and wind. The acrylic cap provides a decorative finish to the window or door assembly. Additionally, the acrylic cap is durable in sunlit environments (e.g., exterior and interior environments) because it is resistant to degradation caused by sunlight. Moreover, the thermoplastic composite structural member has a coefficient of thermal expansion of at least 3.0×10⁻⁵ in/in ° F. or less (e.g., between about 1×10⁻⁵ in/in ° F. and 3.5×10⁻⁵ in/in ° F.) permitting outdoor use of the member without undesirable contraction and expansion. Where the structural member is one of the cladding or the frame, it is easily mated to respective frame or cladding members including materials with similar coefficients of thermal expansion, for instance, ULTREX™. Furthermore, the thermoplastic composite structural member provides enhanced flexural and tensile strength to the window or door assembly. The member thereby provides a stable and durable window or door assembly that is suitable for use in outdoor environments. Further still, the structural member cuts like wood thereby decreasing retooling costs for existing production lines that use wood.

In another option, the structural member is readily manufactured by coforming, for instance, coextruding the thermoplastic material (e.g., acrylonitrile butadiene styrene or the like) including the filaments with the acrylic cap. The nature of the coforming process and the chemical attraction between the thermoplastic and the acrylic cap allow the acrylic cap to couple with the structural member without adhesives or the like. Additionally, the structural member is bendable after being coformed. In one option, the structural member is produced in lineal unbent sections. The lineal sections are subsequently cut and bent as desired to form structural members for window and door assemblies including decorative curved portions.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope of the invention should, therefore, be determined with reference to the appended claims, along with the full scope of equivalents to which such claims are entitled.

What is claimed is:

1. A window or door structural member assembly comprising:
a structural member including at least a thermoplastic and filaments disposed within the thermoplastic, wherein the structural member has a thermal coefficient of expansion of about 3×10⁻⁵ in/in ° F. or less and a heat deflection temperature of about 210° F. or more; and
an acrylic cap co-formed with the structural member and coupled with the structural member.

2. The window or door structural member assembly of claim 1, wherein the structural member includes at least one of a frame member, a sash, or a panel.

3. The window or door structural member assembly of claim 1, wherein the structural member includes a cladding.

4. The window or door structural member assembly of claim 1, wherein at least a portion of the acrylic cap includes a pre-finished wood grain.

5. The window or door structural member assembly of claim 1, wherein the structural member is extruded and the acrylic cap is coextruded with the structural member.

6. The window or door structural member assembly of claim 1, wherein the thermoplastic includes a foamed thermoplastic.

7. The window or door structural member assembly of claim 1, wherein the thermoplastic includes at least one of acrylonitrile butadiene styrene or high impact polystyrene.

8. The window or door structural member assembly of claim 1, wherein the structural member includes wood flour.

9. The window or door structural member assembly of claim 1, wherein the filaments include glass fibers.

10. The window or door structural member assembly of claim 1, wherein the filaments include carbon fibers.

11. The window or door structural member assembly of claim 1, wherein the structural member is hollow.

12. The window or door structural member assembly of claim 1, wherein the acrylic cap includes polymethymethacrylate.

13. A window or door assembly comprising:
a frame;
a cladding coupled along the frame, wherein at least one of the frame and the cladding includes one or more structural members including at least a thermoplastic and filaments disposed within the thermoplastic, and the structural members have a thermal coefficient of expansion of between about 1×10⁻⁵ in/in ° F. and 3.5×10⁻⁵ in/in ° F. and a heat deflection temperature of between about 210° F. and 230° F.; and
one or more acrylic caps co-formed with the structural members and coupled with the structural members.

14. The window or door assembly of claim 13, wherein at least a portion of the frame includes a curved geometry.

15. The window or door assembly of claim 14, wherein at least the portion of the frame with the curved geometry is formed by bending at least the portion of the frame.

16. The window or door assembly of claim 15, wherein at least a portion of the cladding has a curved geometry corresponding to the curved geometry of the frame.

17. The window or door assembly of claim 16, wherein at least the portion of the cladding with the curved geometry is formed by bending at least the portion of the cladding.

18. The window or door assembly of claim 13, wherein the thermoplastic includes a foamed thermoplastic.

19. The window or door assembly of claim 13, wherein the one or more structural members include wood flour.

20. The window or door assembly of claim 13, wherein the filaments include glass fibers.

21. The window or door assembly of claim 13, wherein the one or more structural members are hollow.

22. The window or door assembly of claim 13, wherein the frame includes at least one projection, and the cladding includes at least one groove sized and shaped to receive the at least one projection therein.

23. The window or door assembly of claim 22, wherein the cladding includes at least one claw sized and shaped to grasp the frame.

24. The window or door assembly of claim 13, wherein the structural member is extruded and the acrylic cap is coextruded with the structural member.

25. The window or door assembly of claim 13, wherein the structural members have a thermal coefficient of expansion of between about 1.3×10⁻⁵ in/in ° F. and 3×10⁻⁵ in/in ° F.

26. A method for making a window or door comprising:
extruding one or more window or door structural members, wherein the structural members include at least a thermoplastic and filaments disposed within the thermoplastic, and the structural members have a thermal coefficient of expansion of about 3.5×10⁻⁵ in/in ° F. or less and a heat deflection temperature of 210° F. or more; and
coextruding one or more acrylic caps with the window or door structural members, wherein the acrylic caps are coupled with the window or door structural members.

27. The method for making the window or door of claim 26, further comprising:
heating one or more of the window or door structural members; and
bending at least a portion of the one or more window or door structural members into a curved geometry.

28. The method for making the window or door of claim 27, wherein bending at least the portion of the one or more window or door structural members is performed after extruding one or more window or door structural members and coextruding one or more acrylic caps.

29. The method for making the window or door of claim 26, further comprising:
heating ends of one or more window or door structural members;
and pressing the ends of the one or more window or door structural members into engagement, wherein the ends bond.

30. The method for making the window or door of claim 26, further comprising cutting the one or more window or door structural members and the acrylic caps.

31. The method for making the window or door of claim 26, further comprising coupling cladding to a frame portion, wherein the one or more window or door structural members includes the cladding and the frame portion.

32. The method for making the window or door of claim 31, wherein coupling the cladding to the frame portion includes positioning a projection extending from the frame portion within a groove of the cladding sized and shaped to receive the projection.

33. The method for making the window or door of claim 32, wherein positioning the projection extending from the frame portion within the groove of the cladding includes grasping the frame portion with at least one claw extending from the cladding.
